(19) United States
(12) Patent Application Publication
(10) Pub. No.: US 2026/0073933 A1
(43) Pub. Date: Mar. 12, 2026

(54) SYSTEM AND METHOD FOR LOW COMPLEXITY ON DEVICE AUDIO PROCESSING

(71) Applicant: Samsung Electronics Co., Ltd., Gyeonggi-do (KR)

(72) Inventors: Behnam BABAGHOLAMI MOHAMADABADI, Escondido, CA (US); Mostafa EL-KHAMY, San Diego, CA (US)

(21) Appl. No.: 19/313,413

(22) Filed: Aug. 28, 2025

Related U.S. Application Data
(60) Provisional application No. 63/691,799, filed on Sep. 6, 2024.

(51) Int. Cl. G10L 25/30; G06N 3/04; G10L 21/0216

(52) U.S. Cl. CPC G10L 25/30; G06N 3/04; G10L 21/0216

(57) ABSTRACT

A tiny DNN architecture and a method thereof are disclosed for speech enhancement. The tiny DNN architecture may include an encoder comprising a plurality of GRUs for receiving a noisy input magnitude and extracting features from the noisy input magnitude; an attention module for extracting a higher order relationship between the extracted features from the noisy input magnitude; and a mask decoder for predicting a mask, based on the higher order relationship and the extracted features, to output an estimated clean magnitude.

### CROSS-REFERENCE TO RELATED APPLICATION

This application claims the priority benefit under 35 U.S.C. § 119(e) of U.S. Provisional Application No. 63/691,799, filed on Sep. 6, 2024, the disclosure of which is incorporated by reference in its entirety as if fully set forth herein.

### TECHNICAL FIELD

The disclosure generally relates to processing audio signals. More particularly, the subject matter disclosed herein relates to improvements to tiny (or small) deep neural network (DNN) architecture to increase performance of tiny speech enhancement (SE) models.

### SUMMARY

While modern deep learning-based models have significantly outperformed traditional methods in the area of SE, they often necessitate a relatively large number of parameters and extensive computational power, often making them impractical to be deployed on edge devices in real-world applications. That is, SE algorithms based on DNNs often encounter challenges of limited hardware resources or strict latency requirements when deployed in real world scenarios.

To address these types of problems, tiny DNN models have been developed, which are intended to provide sufficient accuracy for certain tasks while having a minimal size and computational footprint, making them better suited for deployment on resource-constrained devices like embedded systems or Internet of things (IoT) devices. For example, such a library is “tiny-dnn”, a header-only, dependency-free C++ library designed specifically for tiny DNNs.

To provide tiny DNN models, the focus has been on architecture optimization, e.g., reduced layer depth by using fewer layers in the network, smaller filter sizes in convolutional layers (for image tasks), or quantization by reducing the precision of weights and activations to smaller data types (e.g., 8-bit), and different training techniques, such as knowledge distillation, i.e., transferring knowledge from a larger pre-trained model to a smaller one, pruning by removing redundant connections in the network, and regularization to prevent overfitting.

However, despite the reduction in computational overhead achieved by these types of approaches, they still suffer from limited performance. That is, deploying tiny DNN models satisfying hardware constraints often still provides unsatisfactory results.

To overcome these types of issues, systems and methods are described herein for improving in intelligibility and/or overall perceptual quality of audio signals using audio signal processing techniques.

More specifically, a tiny DNN architecture is provided based on gated recurrent units (GRUs), a multi-head-self-attention (MHSA) module, fully connected (FC) layers, and normalization layers to increase performance of a tiny SE model.

The approaches in the present disclosure improve on previous methods by providing a low complexity model for speech enhancement and state of the art SE performance among tiny models.

In an embodiment, a tiny DNN architecture is provided, which includes an encoder comprising a plurality of GRUs for receiving a noisy input magnitude and extracting features from the noisy input magnitude; an attention module for extracting a higher order relationship between the extracted features from the noisy input magnitude; and a mask decoder for predicting a mask, based on the higher order relationship and the extracted features, to output an estimated clean magnitude.

In an embodiment, a method performed using a tiny DNN architecture is provided. The method includes receiving, by an encoder including a plurality of GRUs, a noisy input magnitude; extracting features from the noisy input magnitude; extracting, by an attention module, a higher order relationship between the extracted features from the noisy input magnitude; and predicting, by a mask decoder, a mask, based on the higher order relationship and the extracted features, to output an estimated clean magnitude.

### BRIEF DESCRIPTION OF THE DRAWING

In the following section, the aspects of the subject matter disclosed herein will be described with reference to exemplary embodiments illustrated in the figures, in which:

FIG. 1 illustrates a DNN architecture, according to an embodiment;

FIG. 2 is a flowchart illustrating a method, according to an embodiment;

FIG. 3 is a block diagram of an electronic device in a network environment, according to an embodiment; and

FIG. 4 shows a system including a UE and a gNB in communication with each other environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, a multi-head self-attention (MHSA) module may be a component in deep learning models, like a transformer, that allows the model to simultaneously attend to different aspects of an input sequence. An MHSA module may work by parallelizing multiple “attention heads,” which each perform self-attention. Each head learns different relationships and features from the input in parallel, producing richer contextual information than a single attention layer alone. These individual attention outputs may then be concatenated and linearly transformed to form MHSA output.

As used herein, a mask decoder may refer to a concept of using a mask within a decoder component of a neural network, e.g., a transformer architecture, to prevent a model from looking ahead at future tokens or information during training. Masking may be used to ensure that the decoder uses previously generated tokens or available context to predict a next token, forcing it to learn sequential generation. Additionally, a mask decoder can also refer to models like a masked autodecoder (MAD) that use masking for tasks like multi-task vision learning by randomly masking and reconstructing tokens within a sequence.

As used herein, mini-batch training is a technique used when training DNNs, and may involve dividing an entire training dataset into smaller, more manageable subsets called “mini-batches.” Instead of computing a gradient and updating a model's weights based on the entire dataset (e.g., full-batch gradient descent) or a single data point (e.g., stochastic gradient descent), mini-batch training may be used to update weights after processing each mini-batch.

Audio signal processing may include SE, speaker identification, speech key word identification, etc.

A general goal of SE is to process a noisy speech input signal and provide an estimate of clean speech, i.e., an estimated clean signal. The performance of such systems can be measured in terms of intelligibility and quality of the estimated clean signal (e.g., using objective metrics such as spectro-temporal objective intelligibility (STOI) or perceptual evaluation of speech quality (PESQ)).

STOI generally refers to algorithms that predict how well a listener can understand degraded speech by analyzing the patterns of acoustic energy across time and frequency. These methods may be designed to mimic human auditory processing, which relies on the ability to perceive and integrate these modulations.

PESQ generally refers to methods of assessing how humans perceive the quality of spoken audio, often in the context of telecommunications or speech technology. These methods can be either subjective, involving human listeners, or objective, using algorithms that mimic human perception. For example, PESQ may provide a numerical score based on how a degraded signal compares to a reference signal.

In real world applications, SE can be applied to mobile phones or hearing aids.

Additionally, some SE applications require low-latency processing, i.e., the delay between the estimated clean signals in relation to the noisy signal cannot be too big. Otherwise, the application of such a system will not result in an improvement in speech communication.

Additionally, in real-world applications, SE algorithms can be constrained by the capabilities of mobile hardware.

According to an embodiment of the disclosure, a highly efficient DNN architecture is provided, which includes uni-directional GRUs, an MHSA module, FC layers, and normalization layers.

By considering a magnitude of a noisy spectrogram as input, a stack of uni-directional GRUs may be utilized to compress the input and extract certain features, such as magnitude spectrogram, log-magnitude spectrogram, Mel-scaled features, or magnitude spectral features, from the noisy magnitude. Thereafter, an MHSA module may be used to further extract higher order relationships between the GRU extracted features. The FC layers may then be utilized to estimate clean speech magnitude.

A DNN architecture as described above, may have only 578K parameters with a complexity of 0.077 Gaussian multiple-access channels (GMACs), making it particularly well-suited for implementation on embedded devices with limited resources.

With a proper loss function by incorporating a differentiable PESQ loss combined with scale-invariant signal-to-distortion ratio (SI-SDR) loss to standard SE loss functions, experimental results have demonstrated that the DNN architecture as described above achieves superior performance over current tiny SE models, and also attains noise suppression capabilities that are on par with, or potentially exceed, many techniques with much higher complexity.

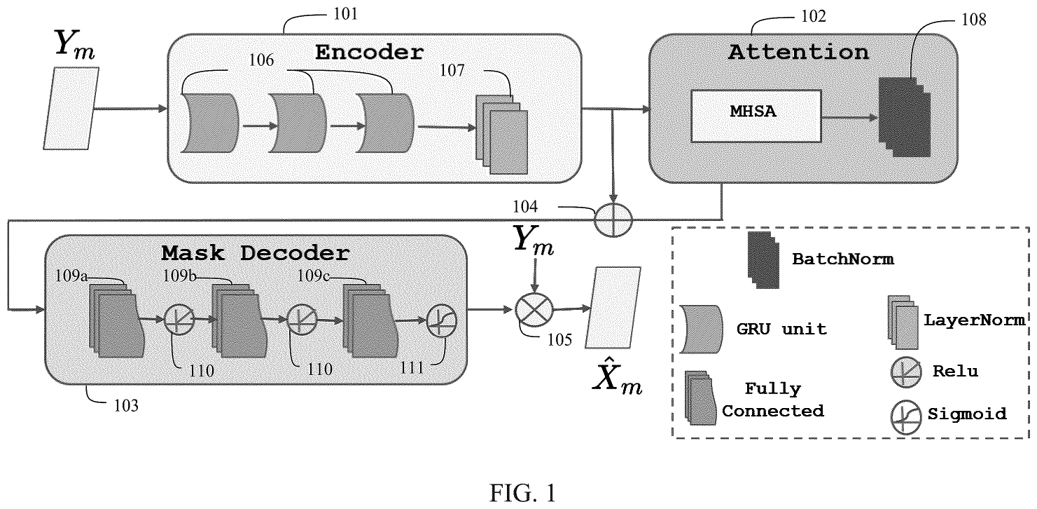

FIG. 1 illustrates a DNN architecture, according to an embodiment.

Referring to FIG. 1, the DNN architecture includes an encoder 101, an attention module, i.e., an MHSA module, 102, and a mask decoder 103. The DNN architecture also includes a skip connection 104, i.e., a shortcut that allow data and gradients to bypass one or more layers, improving training for very deep networks by preventing vanishing gradients, and a mixer 105.

Using the DNN architecture of FIG. 1, x∈R^{N} denotes an N-dimensional time domain speech signal corrupted by noise n and a goal is to extract x from y=x+n. More specifically, denoising may be applied in a time-frequency (TF) domain, whereby y is transformed into Y using a short-time Fourier transform (STFT).

Herein, a denoiser is a mask M∈R₊, which is applied to a spectrogram, such that an approximation of a target may be given by Equation (1).

$$\hat{X} = M ⊙ \vert Y \vert exp ( ∢ Y ) \qquad ( 1 )$$

In Equation (1), ⊙ denotes a Hadamard product, |Y| denotes the magnitude of the noisy input Y, and ≮Y is a phase of a noisy input. The mask may be a function of Y and learnable parameters θ, i.e., M=f_{θ}(Y). Specifically, f_{θ}(·) may be a neural network with a learnable parameter θ.

For a distorted speech waveform y∈R^{L×1}, an STFT operation may first convert the waveform into a complex spectrogram γₒ∈R^{T×F×2}, where T and F denote time and frequency dimensions, respectively.

Thereafter, the compressed spectrogram Y may be obtained by a power-law compression, as shown in Equation (2):

$$Y = {\vert {Y}_{o} \vert}^{c} {e}^{j {Y}_{p}} = {Y}_{m} {e}^{j {Y}_{p}} = {Y}_{r} + {jY}_{i} \qquad ( 2 )$$

In Equation (2), γₘ, γₚ, γᵣ, and γᵢ denote magnitude, phase, real components, and imaginary components of the compressed spectrogram, respectively, and c is a compression exponent that is set to c=0.3.

Given the input noisy feature Y∈R^{B×T×F}, where B denotes the batch size, the encoder 101 includes three uni-directional multi-layer GRUs 106. Each GRU 106 may include T hidden states, where the number of features in each hidden state is set to [F/2], and a Tanh activation. By considering the magnitude of the noisy spectrogram γₘ as input, first, the stack of three uni-directional multi-layer GRUs 106 may be utilized to compress the input and extract certain features from the noisy magnitude γₘ.

According to an embodiment, a layer normalization module 107 is also provided after the GRUs 106. The layer normalization module 107 may standardize the activations within each layer for every individual input sample, calculating mean and variance across its features. More specifically, the layer normalization module 107 may normalize activations within a layer to have zero mean and unit variance for each input sample, by shifting outputs of all activations in the layer by their mean, in order to modify them to have zero mean. Thereafter, the layer normalization module 107 may may scale the outputs by the standard deviation so the activations of the layer will have unit variance for each sample. This technique may be used to stabilize and accelerate deep learning training, especially for recurrent neural networks (RNNs) and transformers, by mitigating internal covariate shift, allowing higher learning rates, faster convergence, and better generalization, regardless of batch size.

Goals of the encoder 101 operations may include downsampling the input features along the frequency axis and performing efficient feature extraction.

The MHSA module 102 is successful in speech recognition and separation as it can capture long-distance dependencies. The MHSA module 102 may be used to further extract a higher order relationship between the extracted features from the GRUs 106.

In FIG. 1, the MHSA module 102 has a relatively simple construction, with four heads to further capture time dependency. However, the present disclosure in not limited thereto, and the MHSA module 102 may include fewer or more heads, e.g., depending on system and/or performance requirements.

According to an embodiment, the skip connection 104 is applied between the last GRU 106 and the MHSA module 102 in order to aggregate previous feature maps in order to extract different feature levels. The skip connection 104 may provide an efficient flow of information directly from the encoder 101, along with the output of the MHSA module 102, to the mask decoder 103, without adding significant additional complexity to the DNN architecture.

According to an embodiment, a batch normalization layer module 108 may be applied at the end of MHSA module 102. The batch normalization 108 may standardize activations within each layer by computing mean and variance across a mini-batch. This may be used to stabilize and speed up deep network training, reducing internal covariate shift, allowing higher learning rates, and regularizing the model, using moving averages for inference. For example, the batch normalization layer may learn scaling and shifting parameters during training to make each activation have zero mean and unit variance when calculated over the input training batch of samples.

As described above, the mask decoder 103 may receive information from the encoder 101, i.e., the extracted features, along with the output of the MHSA module 102, i.e., the extracted higher order relationship between the extracted features from the noisy input magnitude, and then may predict a mask that may be utilized to output an estimated clean magnitude. That is, a goal of the mask decoder 103 may include predicting a mask that will be element-wise multiplied by input magnitude γₘ at the mixer 105 to output estimated clean magnitude \hat{λ}ₘ, i.e., a masked magnitude.

In FIG. 1, the mask decoder 103 includes three FC layers 109a, 109b, and 109c. The three FC layers 109a, 109b, and 109c may be utilized to estimate clean speech magnitude. The FC layers 109a and 109b, except for the last output FC layer 109c, may use rectified linear unit (ReLU) activations 110. Since the mask decoder 103 estimates a real-valued suppression gain, a Sigmoid activation 111 may be applied to the last FC layer to ensure positive output. The FC layers 109a, 109b, and 109c may eliminate a need for a complete decoder architecture, which is sometimes used to upsample bottleneck feature representations, after the MHSA module 102.

The masked magnitude may be combined with a noisy phase γₚ to obtain a magnitude-enhanced complex spectrogram in accordance with Equations (3) and (4):

$${\hat{X}}_{r} = {\hat{X}}_{m} cos ( {Y}_{p} ) \qquad ( 3 )$$

$${\hat{X}}_{i} = {\hat{X}}_{m} sin ( {Y}_{p} ) \qquad ( 4 )$$

The power-law compression may then be inverted on the estimated complex spectrogram (\hat{X}ᵣ, \hat{X}ᵢ) and an inverse STFT (ISTFT) may be applied to obtain the estimated time-domain clean signal \hat{x}.

According to an embodiment of the disclosure, a magnitude loss L_{Mag} and a complex loss L_{RI} may be utilized in the TF-domain, as in Equations (5) and (6):

$${L}_{M a g} = {E}_{{X}_{m} , {\hat{X}}_{m}} [ {‖ {X}_{m} - {\hat{X}}_{m} ‖}^{2} ] \qquad ( 5 )$$

$${L}_{R 1} = {E}_{{X}_{r} , {\hat{X}}_{r}} [ {‖ {X}_{r} - {\hat{X}}_{r} ‖}^{2} ] + {E}_{{X}_{i} , {\hat{X}}_{i}} [ {‖ {X}_{i} - {\hat{X}}_{i} ‖}^{2} ] \qquad ( 6 )$$

In Equations (6) and (7), E denotes an expectation operator, e.g., an averaging operator (averaged over all training data).

According to an embodiment, a differentiable PESQ algorithm may be used as a loss function for the model. For example, this loss may be denoted as shown in Equation (7).

$${L}_{P E S Q} = {E}_{x , \hat{x}} [ PESQ ( x , \hat{x} ) ] \qquad ( 7 )$$

In Equation (7), \hat{x} is the enhanced waveform and x is the clean target waveform.

When the PESQ metric is dominant in a loss function, it may lead to a poor listening quality score.

To diminish negative effects of a PESQ loss, a scale invariant signal-to-distortion ratio (SI-SDR) loss may be utilized. For example, the SI-SDR) loss (L_{SI-SDR}) may be defined as in Equation (8).

$${L}_{SI - SDR} = {𝔼}_{x , \hat{x}} [ 10 {log}_{10} ( \frac{{‖ \frac{{\hat{x}}^{T} x}{{‖ x ‖}^{2}} x ‖}^{2}}{{‖ \frac{{\hat{x}}^{T}}{{‖ x ‖}^{2}} x - \hat{x} ‖}^{2}} ) ] \qquad ( 8 )$$

Further, an additional penalization in the resultant waveform L_{Time} may be utilized to improve restored speech quality:

$${L}_{T i m e} = {E}_{x , \hat{x}} [ {‖ x - \hat{x} ‖}_{1} ] \qquad ( 9 )$$

A final loss function may be formulated as shown in Equation (10):

$$L = {γ}_{0} {L}_{M a g} + {γ}_{1} {L}_{RI} + {γ}_{2} {L}_{T i m e} + {γ}_{3} {L}_{P E S Q} + {γ}_{4} {L}_{SI - SDR} \qquad ( 10 )$$

In Equation (10), γ₀, γ₁, γ₂, γ₃, and γ4 are the weights of the corresponding losses and they may be chosen to reflect equal importance.

While the above-described embodiment describes objective optimization using the examples of differential PESQ and SI-SDR, the present disclosure is not limited thereto. For example, other objectives such as time-domain similarity to clean signal and frequency domain (e.g., magnitude and complex signal) similarity to clean signal may also be optimized.

In testing, the DNN architecture illustrated in FIG. 1 exhibits superior computational efficiency compared to current tiny DNN models. Notably, the DNN architecture illustrated in FIG. 1 achieves significantly lower complexity, e.g., just 78% of MAC operations compared to a tiny SE model (ULCNet).

Additionally, in terms of model parameters, models for the DNN architecture illustrated in FIG. 1 are smaller with 577K parameters, compared to the next best model, i.e., ULCNet, which has 688K parameters.

Further, while the DNN architecture illustrated in FIG. 1 has a much smaller computational load and utilizes fewer parameters, it still exhibits superior performance in various metrics, surpassing other tiny SE methods.

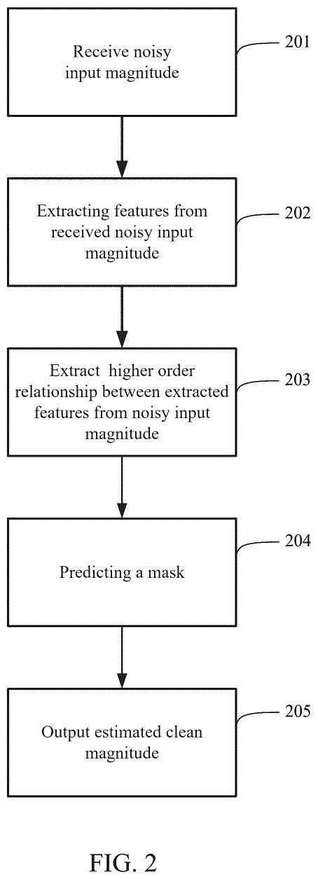

FIG. 2 is a flowchart illustrating a method, according to an embodiment of the disclosure. For example, the method of FIG. 2 is described below with reference to the a tiny DNN architecture as illustrated in FIG. 1. However, the present disclosure is not limited thereto.

Referring to FIG. 2, in step 201, the tiny DNN architecture, e.g., the encoder 101 as illustrated in FIG. 1, which includes a plurality of GRUs 106, receives a noisy input magnitude, i.e., Yₘ.

In step 202, the encoder 101 extracts features from the noisy input magnitude. For example, the extracted features may include magnitude spectrogram, log-magnitude spectrogram, Mel-scaled features, or magnitude spectral features.

In step 203, the tiny DNN architecture, e.g., the attention module 102 (i.e., an MHSA module) as illustrated in FIG. 1, extracts a higher order relationship between the extracted features from the noisy input magnitude.

In step 204, the tiny DNN architecture, e.g., the mask decoder 103 as illustrated in FIG. 1, predicts a mask, based on the higher order relationship and the extracted features.

In step 205, the tiny DNN architecture outputs an estimated clean magnitude based on the estimated mask. For example, the tiny DNN architecture may output the estimated clean magnitude by element-wise multiplying the mask by the noisy input magnitude.

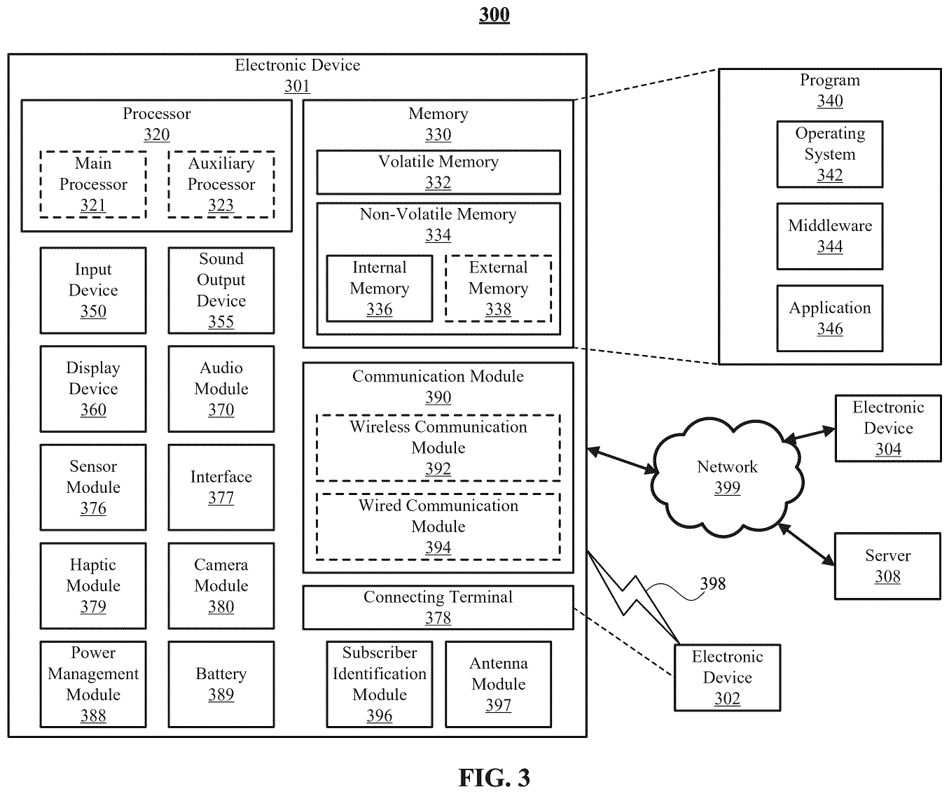

FIG. 3 is a block diagram of an electronic device in a network environment 300, according to an embodiment. For example, the electronic device may be an edge device utilizing a DNN architecture as illustrated in FIG. 1.

Referring to FIG. 3, an electronic device 301 in a network environment 300 may communicate with an electronic device 302 via a first network 398 (e.g., a short-range wireless communication network), or an electronic device 304 or a server 308 via a second network 399 (e.g., a long-range wireless communication network). The electronic device 301 may communicate with the electronic device 304 via the server 308. The electronic device 301 may include a processor 320, a memory 330, an input device 350, a sound output device 355, a display device 360, an audio module 370, a sensor module 376, an interface 377, a haptic module 379, a camera module 380, a power management module 388, a battery 389, a communication module 390, a subscriber identification module (SIM) card 396, or an antenna module 397. In one embodiment, at least one (e.g., the display device 360 or the camera module 380) of the components may be omitted from the electronic device 301, or one or more other components may be added to the electronic device 301. Some of the components may be implemented as a single integrated circuit (IC). For example, the sensor module 376 (e.g., a fingerprint sensor, an iris sensor, or an illuminance sensor) may be embedded in the display device 360 (e.g., a display).

The processor 320 may execute software (e.g., a program 340) to control at least one other component (e.g., a hardware or a software component) of the electronic device 301 coupled with the processor 320 and may perform various data processing or computations.

As at least part of the data processing or computations, the processor 320 may load a command or data received from another component (e.g., the sensor module 376 or the communication module 390) in volatile memory 332, process the command or the data stored in the volatile memory 332, and store resulting data in non-volatile memory 334. The processor 320 may include a main processor 321 (e.g., a central processing unit (CPU) or an application processor (AP)), and an auxiliary processor 323 (e.g., a graphics processing unit (GPU), an image signal processor (ISP), a sensor hub processor, or a communication processor (CP)) that is operable independently from, or in conjunction with, the main processor 321. Additionally or alternatively, the auxiliary processor 323 may be adapted to consume less power than the main processor 321, or execute a particular function. The auxiliary processor 323 may be implemented as being separate from, or a part of, the main processor 321.

The auxiliary processor 323 may control at least some of the functions or states related to at least one component (e.g., the display device 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). The auxiliary processor 323 (e.g., an image signal processor or a communication processor) may be implemented as part of another component (e.g., the camera module 380 or the communication module 390) functionally related to the auxiliary processor 323.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334. Non-volatile memory 334 may include internal memory 336 and/or external memory 338.

The program 340 may be stored in the memory 330 as software, and may include, for example, an operating system (OS) 342, middleware 344, or an application 346. For example, the program 340 may include various methods disclosed herein, e.g., the method illustrated in FIG. 2.

The input device 350 may receive a command or data to be used by another component (e.g., the processor 320) of the electronic device 301, from the outside (e.g., a user) of the electronic device 301. The input device 350 may include, for example, a microphone, a mouse, or a keyboard.

The sound output device 355 may output sound signals to the outside of the electronic device 301. The sound output device 355 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 360 may visually provide information to the outside (e.g., a user) of the electronic device 301. The display device 360 may include, for example, a display, a hologram device, or a projector and control circuitry to control a corresponding one of the display, hologram device, and projector. The display device 360 may include touch circuitry adapted to detect a touch, or sensor circuitry (e.g., a pressure sensor) adapted to measure the intensity of force incurred by the touch.

The audio module 370 may convert a sound into an electrical signal and vice versa. The audio module 370 may obtain the sound via the input device 350 or output the sound via the sound output device 355 or a headphone of an external electronic device 302 directly (e.g., wired) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. The sensor module 376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device 302 directly (e.g., wired) or wirelessly. The interface 377 may include, for example, a high-definition multimedia interface (HDMI), a universal serial bus (USB) interface, a secure digital (SD) card interface, or an audio interface.

A connecting terminal 378 may include a connector via which the electronic device 301 may be physically connected with the external electronic device 302. The connecting terminal 378 may include, for example, an HDMI connector, a USB connector, an SD card connector, or an audio connector (e.g., a headphone connector).

The haptic module 379 may convert an electrical signal into a mechanical stimulus (e.g., a vibration or a movement) or an electrical stimulus which may be recognized by a user via tactile sensation or kinesthetic sensation. The haptic module 379 may include, for example, a motor, a piezoelectric element, or an electrical stimulator.

The camera module 380 may capture a still image or moving images. The camera module 380 may include one or more lenses, image sensors, image signal processors, or flashes. The power management module 388 may manage power supplied to the electronic device 301. The power management module 388 may be implemented as at least part of, for example, a power management integrated circuit (PMIC).

The battery 389 may supply power to at least one component of the electronic device 301. The battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the AP) and supports a direct (e.g., wired) communication or a wireless communication. The communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device via the first network 398 (e.g., a short-range communication network, such as BLUETOOTH™, wireless-fidelity (Wi-Fi) direct, or a standard of the Infrared Data Association (IrDA)) or the second network 399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 392 may identify and authenticate the electronic device 301 in a communication network, such as the first network 398 or the second network 399, using subscriber information (e.g., international mobile subscriber identity (IMSI)) stored in the subscriber identification module 396.

The antenna module 397 may transmit or receive a signal or power to or from the outside (e.g., the external electronic device) of the electronic device 301. The antenna module 397 may include one or more antennas, and, therefrom, at least one antenna appropriate for a communication scheme used in the communication network, such as the first network 398 or the second network 399, may be selected, for example, by the communication module 390 (e.g., the wireless communication module 392). The signal or the power may then be transmitted or received between the communication module 390 and the external electronic device via the selected at least one antenna.

Commands or data may be transmitted or received between the electronic device 301 and the external electronic device 304 via the server 308 coupled with the second network 399. Each of the electronic devices 302 and 304 may be a device of a same type as, or a different type, from the electronic device 301. All or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 301. The electronic device 301 may provide the outcome, with or without further processing of the outcome, as at least part of a reply to the request. To that end, a cloud computing, distributed computing, or client-server computing technology may be used, for example.

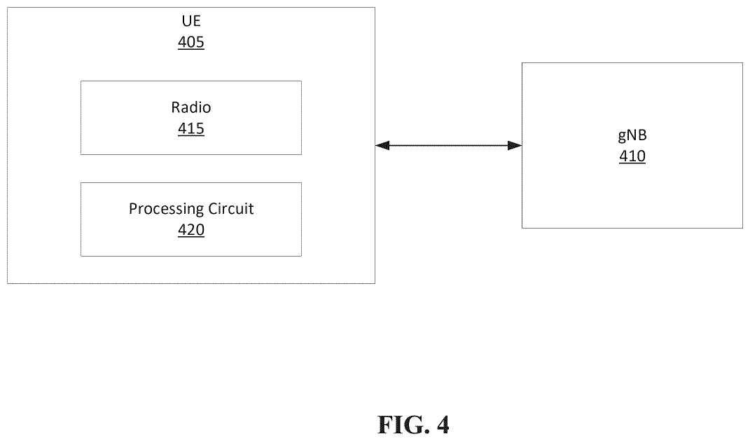

FIG. 4 shows a system including a UE 405 and a gNB 410, in communication with each other environment, according to an embodiment.

Referring to FIG. 4, the UE may include a radio 415 and a processing circuit (or a means for processing) 420, which may perform various methods disclosed herein, e.g., the method illustrated in FIG. 2. For example, the processing circuit 420 may receive, via the radio 415, transmissions from the network node (gNB) 410, and the processing circuit 420 may transmit, via the radio 415, signals to the gNB 410.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A tiny deep neural network (DNN) architecture, comprising:
an encoder comprising a plurality of gated recurrent units (GRUs) for receiving a noisy input magnitude and extracting features from the noisy input magnitude;
an attention module for extracting a higher order relationship between the extracted features from the noisy input magnitude; and
a mask decoder for predicting a mask, based on the higher order relationship and the extracted features, to output an estimated clean magnitude.

2. The tiny DNN architecture of claim 1, wherein the attention module comprises a multi-head-self-attention (MHSA) module.

3. The tiny DNN architecture of claim 2, wherein the attention module further comprises a normalization module after the MHSA module.

4. The tiny DNN architecture of claim 3, wherein the normalization module comprises a batch normalization module.

5. The tiny DNN architecture of claim 2, wherein the tiny DNN architecture is trained to optimize one or more of objectives among differential perceptual evaluation of speech quality (PESQ), scale invariant signal-to-distortion ratio (SI-SDR), time-domain similarity to clean signal, or frequency domain similarity to clean signal.

6. The tiny DNN architecture of claim 1, wherein the mask decoder includes a plurality of fully connected (FC) layers.

7. The tiny DNN architecture of claim 6, wherein each of the plurality of FC layers, except for a last output FC layer, uses rectified linear unit (ReLU) activation.

8. The tiny DNN architecture of claim 7, wherein the last output FC layer uses a Sigmoid activation.

9. The tiny DNN architecture of claim 1, wherein the encoder further comprises a normalization module after the GRUs.

10. The tiny DNN architecture of claim 9, wherein the normalization module comprises a layer normalization module.

11. The tiny DNN architecture of claim 1, further comprising a skip connection between the encoder and the attention module to aggregate previous feature maps to extract different feature levels.

12. The tiny DNN architecture of claim 11, further comprising a mixer for element-wise multiplying the mask by the noisy input magnitude to output the estimated clean magnitude.

13. A method performed using a tiny deep neural network (DNN) architecture, the method comprising:
receiving, by an encoder including a plurality of gated recurrent units (GRUs), a noisy input magnitude;
extracting features from the noisy input magnitude;
extracting, by an attention module, a higher order relationship between the extracted features from the noisy input magnitude; and
predicting, by a mask decoder, a mask, based on the higher order relationship and the extracted features, to output an estimated clean magnitude.

14. The method of claim 13, wherein the attention module comprises a multi-head-self-attention (MHSA) module.

15. The method of claim 14, further comprising training the tiny DNN architecture to optimize one or more of objectives among differential perceptual evaluation of speech quality (PESQ), scale invariant signal-to-distortion ratio (SI-SDR), time-domain similarity to clean signal, or frequency domain similarity to clean signal.

16. The method of claim 15, wherein the normalization module comprises a batch normalization module.

17. The method of claim 13, wherein the mask decoder includes a plurality of fully connected (FC) layers.

18. The method of claim 13, wherein each of the plurality of FC layers, except for a last output FC layer, uses rectified linear unit (ReLU) activation.

19. The method of claim 18, wherein the last output FC layer uses a Sigmoid activation.

20. The method of claim 13, further comprising element-wise multiplying the mask by the noisy input magnitude to output the estimated clean magnitude.
